(19) United States
(12) Patent Application Publication
(10) Pub. No.: US 2006/0133311 A1
(43) Pub. Date: Jun. 22, 2006

(54) Method of improving the management of mobility in a cellular mobile communications system

(75) Inventors: Nicolas Drevon, Paris (FR); Serge Baudet, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/304,811

(22) Filed: Dec. 16, 2005

(30) Foreign Application Priority Data
Dec. 17, 2004 (FR) 0453038

(51) Int. Cl. H04Q 7/00

(52) U.S. Cl. 370/328

(57) ABSTRACT

In one of its aspects, the present invention provides a method of improving the management of mobility in a cellular mobile communications system in which cells are grouped together in location structures comprising cells that support different radio access technologies, said method comprising steps in which:
a mobile terminal (MT) in a given cell sends (1) to a network entity (CN) a request to register in a location structure including said cell; and
on receiving said request, said network entity (CN) transmits (2) to the mobile terminal (MT) a reply including at least one radio access technology (RAT) indication relating to at least one radio access technology that is authorized and/or to at least one radio access technology that is not authorized for said mobile terminal, at least in said location structure.

The present invention relates in general to cellular mobile communications systems.

In general, cellular mobile communications systems are the subject of standardization and, for further information, reference can be made to the corresponding standards, published by the corresponding standards organizations.

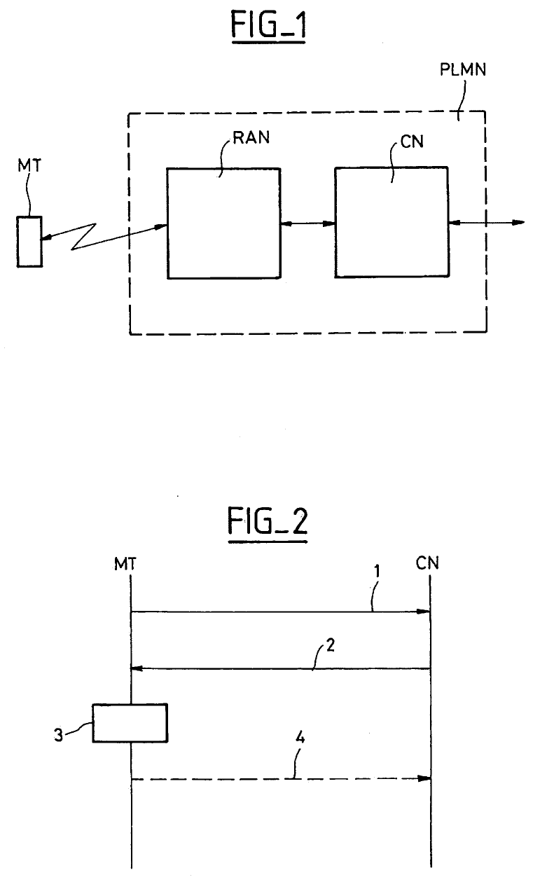

The general structure of such a system is recalled briefly with reference to FIG. 1. Such a system comprises a mobile communications network known as the public land mobile network (PLMN) that communicates with mobile terminals (MT) and with external networks (not shown specifically).

The network itself includes a radio access network (RAN) serving mainly to transmit and to manage radio resources over the radio interface between the network and the mobile terminals, and a core network (CAN) serving mainly to manage and to convey calls to and from the mobile terminals.

In general, these systems are of cellular architecture, and in order to manage user mobility, cells are grouped together in location structures known as location areas (LA) for circuit mode services or as routing areas (RA) that are included in the location areas, for packet mode services.

By way of example, the description below relates to location structures corresponding to location areas (referred to more simply as LAs below), and to the mechanism whereby a terminal selects a cell when in a mode known as “idle” mode.

A terminal informs the network, generally by means of a location updating procedure of any change of LA due to a change in the cell selected for accessing the network. This enables the network firstly to search for the terminal in the corresponding LA in the event of an incoming call for that terminal (with this being done by a search or “paging” procedure), and secondly to control the rights of the user to access the selected cell, prior to registering the user in the corresponding LA.

In such a location updating procedure, the mobile terminal transmits a message to the network known as a location updating request (LUR).

After verifying the rights of the user, in particular on the basis of a subscriber profile, the network can respond in two possible ways:
in the event of a positive response, the message returned by the network to the mobile terminal is a location updating accept (LUA) message; the user is then registered in the new LA;
in the event of a negative response, the message returned by the network to the mobile terminal is a location updating reject (LUR) message.

Furthermore, changes in technology make it necessary to distinguish between different radio access technologies (RATs).

One example of an RAT is the global system for mobile communication (GSM) that makes use of the frequency division multiple access/time division multiple access (FDMA/TDMA) access technique, in particular in so-called “second” generation systems.

Another example of an RAT is wideband code division multiple access (W-CDMA), and also time division code division access (TD-CDMA) used in particular in so-called “third” generation systems, such as the universal mobile communication system (UMTS), in particular.

Naturally other examples of RATs are also possible, for example CDMA 2000, unlicensed mobile access (UMA), WLAN-3GPP, etc. It is also possible for the frequency band to be a discriminating element, such as for example GSM 900 or GSM 1800.

In addition, any one system (or operator) can use different RATs (such a system can be referred to as a “multi-RAT” system). This corresponds for example to third generation infrastructures being introduced progressively in existing second generation infrastructures, making it possible in particular for services that are supported in common by both generations, such as in particular telephony type services, to be provided with continuity of service, benefiting from the existing coverage as supplied by existing second generation infrastructures.

In such a system of the “multi-RAT” type, various subscription profiles can be offered by the operators; in particular, the subscription profile may be such that access is allowed only to one or more particular RATs, while access to other RATs is not allowed.

A problem to be solved is than that of allowing a mobile terminal capable of supporting different RATs (e.g. GSM and UMTS) to access only certain particular RATs (e.g. GSM but not UMTS).

One solution is to configure the LAs in such a manner that the cells in one LA are associated with a single RAT (such an LA could be referred to as a “single-RAT” LA), and to accept a registration request from the terminal only in an LA associated with that RAT.

Such a single-RAT LA type solution suffers in particular from the drawback of pointlessly increasing the location updating traffic since a location updating procedure is then necessary solely because a mobile terminal is going from an LA associated with one RAT to an LA associated with another RAT (which is likely to happen quite often, particularly relatively more frequently than changing LA in a single-RAT system).

One solution for avoiding such drawbacks is to configure the LAs in such a manner that the various cells of an LA can be associated with different RATs.

However, with such a multi-RAT LA type solution, the present state of the standard does not make it possible to authorize a mobile terminal capable of supporting different RATs to access only some of those RATs; all of the cells of a multi-RAT LA are authorized regardless of the RAT. In other words, in the present state of the standard, access right limitations (in particular in terms of subscription profile) cannot be taken into account at a level lower than that of an LA, which raises problems for access right limitations on the basis of certain criteria, and in particular on the basis of the RAT.

A particular object of the present invention is to solve those problems in full or in part and/or to avoid those drawbacks in full or in part. In particular, one of the objects of the present invention is to preserve the advantages of the multi-RAT LA solution without presenting its drawbacks. More generally, one of the objects of the present invention is to improve the management of mobility in systems capable of using different RATs.

In one aspect, the present invention provides a method of improving the management of mobility in a cellular mobile communications system in which cells are grouped together in location structures comprising cells that support different radio access technologies, said method comprising steps in which:
a mobile terminal in a given cell sends to a network entity a request to register in a location structure including said cell; and
on receiving said request, said network entity transmits to the mobile terminal a reply including at least one radio access technology indication relating to at least one radio access technology that is authorized and/or to at least one radio access technology that is not authorized for said mobile terminal, at least in said location structure.

In another aspect, the present invention provides a mobile terminal including means for implementing such a method.

In another aspect, the present invention provides a subscriber identity module, also known as a SIM/USIM for “GMS subscriber identity module/universal subscriber identity module”, associated with a mobile terminal and including means for implementing such a method.

In another aspect, the present invention provides a mobile communications network entity including means for implementing such a method.

Other objects and characteristics of the present invention appear on reading the following description of an embodiment, given with reference to the accompanying drawings, in which:

FIG. 1 recalls the general architecture of a mobile communications system;

FIG. 2 is a diagram for illustrating an example of the method of the present invention;

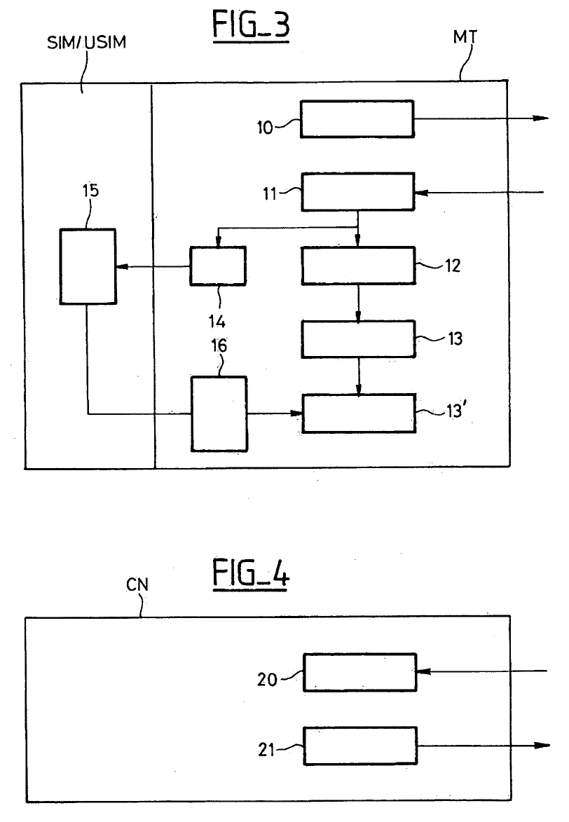

FIG. 3 is a diagram for illustrating an example of means capable of being used in a mobile terminal and in a subscriber identity module associated with the terminal for implementing a method in accordance with the present invention; and

FIG. 4 is a diagram for showing an example of means capable of being used in a network entity for implementing a method in accordance with the present invention.

FIG. 2 shows an example of a method in accordance with the invention.

In a step referenced 1, a mobile terminal MT transmits a registration request to a network entity, generally corresponding to a core network server entity.

Specifically, for circuit-mode services, such a core network server entity corresponds to an entity of the mobile switching center/visitor location register (MSC/VLR) type. For packet-mode services, such a core network server entity corresponds to a serving GPRS support node (SGSN) type entity.

Said registration request can be generated by the terminal in a usual way (and is consequently not described again herein in greater detail). In an example, said registration request can correspond to a location update request as is generally transmitted on the mobile terminal changing the cell it has selected, when that coincides with a change of LA.

In a step referenced 2, the CN entity responds to said request by transmitting a reply to the mobile terminal MT.

In addition to the information contained in such a reply in the usual way (and consequently not re-described herein in greater detail), the reply includes at least one radio access technology indication relating to at least one RAT that is authorized and/or to at least one RAT that is not authorized for said mobile terminal, at least in said location structure.

The information relating to the authorized and/or non-authorized RAT(s) for a mobile terminal can be updated in the network following any change such as reconfiguration, extension, . . . etc. In addition, if the CN entity in question does not itself possess such information, it can obtain the information from another network entity, in particular such as a database of the home location register (HLR) type or of the visitor location register (VLR) type.

In an example, said RAT indication is explicit, and said reply includes at least one specific parameter.

In another example, said RAT indication is implicit, with the various RATs being assumed to be authorized for said terminal providing said reply does not contain any specific parameter.

In an example, said response further includes a geographical area indication relating to a geographical area applicable to said authorization and/or non-authorization.

For example, said geographical area indication specifies whether said authorization and/or non-authorization is applicable solely for said location structure (location area LA), or for the entire public land mobile terminal (PLMN).

In an example, said reply may correspond to a message accepting the location update request.

In another example, said reply may correspond to a message rejecting the location update request.

Examples other than those given above are naturally also possible, and it will be understood that it is not possible herein to give an exhaustive list of all possible examples.

On receiving said reply, and in addition to the processing performed in the usual way (and consequently not described again herein in greater detail), in a step referenced 3 the mobile terminal extracts from said reply information relating to at least one authorized RAT and/or at least one non-authorized RAT, and this information can subsequently be used by the terminal in various ways.

In an example:
the terminal determines whether the RAT associated with the selected cell (generally broadcast with other system information in the cell in question) corresponds to a non-authorized RAT, depending on the information as extracted in this way from said reply;
if the RAT is not authorized, then the mobile terminal MT selects another cell associated with an authorized RAT, and where necessary (in particular when making a new change of LA), as represented by dashed lines in step 4, sends a new registration request to the CN entity.

In an example:
the terminal causes information corresponding to at least one non-authorized RAT as indicated by said reply to be stored in memory means that can be provided in particular in a subscriber identity module associated with said mobile terminal (also known as a GSM subscriber identity module/universal subscriber identity module (SIM/USIM)); and
prior to selecting a cell, the mobile terminal verifies that the cell is not associated with an RAT that is not authorized according to the information as stored in this way.

Said stored information can be updated if new information relating to at least one non-authorized RAT is received from the network, as can happen in particular when making a new change of LA.

Said stored information can be deleted, e.g. when changing public land mobile network (PLMN), or when removing the SIM/USIM card, or under the control of the user, . . . , etc.

FIG. 3 shows an example of means that can be used in a mobile terminal and in a subscriber identity module associated with the terminal to implement a method in accordance with the present invention.

In the example shown, the mobile terminal referenced MT comprises (in addition to other means that are conventional and not described herein):
means referenced 10 for transmitting to a network entity in a given cell a request to register in a location structure including said cell; and
means referenced 11 for receiving a reply from said network entity in response to said request, the reply including at least one RAT indication relating to at least one RAT that is authorized and/or to at least one RAT that is not authorized for said mobile terminal, at least in said location structure.

In an example, the mobile terminal MT further comprises:
means referenced 12 for receiving said response, for determining whether the RAT associated with said cell (generally broadcast together with system information in the cell in question) corresponds to a non-authorized RAT as specified by said reply; and
means referenced 13 for acting if the RAT is not authorized to select another cell associated with an RAT that is authorized (the means 13 can thus co-operate with cell selector means referenced 13′ provided in conventional manner in the terminal).

In an example, the mobile terminal MT further comprises:
means referenced 14 for acting, on receiving said reply, to cause information corresponding to at least one non-authorized RAT as specified in said reply to be stored in memory means referenced 15, possibly being provided in particular in an associated subscriber identity module referenced SIM/USIM; and
means referenced 16 for acting prior to selecting a cell to verify that said cell is not associated with an RAT that is not authorized by the information as stored in this way (the means 16 can thus co-operate with cell selector means referenced 13′ as provided in conventional manner in the terminal).

A subscriber identity referenced SIM/USIM, associated with the mobile terminal MT can thus comprise (in addition to other means that are conventional and not recalled herein):
means referenced 15 for storing information corresponding to at least one RAT that is not authorized for the mobile terminal associated with said module, which information is received from a network entity in response to a registration request sent from said terminal.

FIG. 4 shows an example of means that can be used in a network entity, such as in particular a core network server entity, for implementing a method in accordance with the present invention.

In the example shown, such a network entity, referenced CN, comprises (in addition to other means that are conventional and not recalled herein):
means referenced 20 for receiving from a mobile terminal in a given cell a request to register in a location structure including said cell; and
means referenced 21 for transmitting a reply to the mobile terminal in response to said request, the reply including at least an RAT indication relating to at least one RAT that is authorized and/or at least one RAT that is not authorized for said mobile terminal, at least in said location structure.

The various means shown in FIGS. 3 and 4 can operate in application of the method described above with reference to FIG. 2; the particular implementation thereof does not present any particular difficulty for the person skilled in the art, so such means do not need to be described herein in a manner more detailed than by their function.

What is claimed is:

1. A method of improving the management of mobility in a cellular mobile communications system in which cells are grouped together in location structures comprising cells that support different radio access technologies, said method comprising steps in which:
a mobile terminal (MT) in a given cell sends (1) to a network entity (CN) a request to register in a location structure including said cell; and
on receiving said request, said network entity (CN) transmits (2) to the mobile terminal (MT) a reply including at least one radio access technology (RAT) indication relating to at least one radio access technology that is authorized and/or to at least one radio access technology that is not authorized for said mobile terminal, at least in said location structure.

2. A method according to claim 1, in which said radio access technology indication is explicit, said response including at least one specific parameter.

3. A method according to claim 1, in which said radio access technology indication is implicit, the various radio access technologies being assumed to be authorized for said terminal providing said reply does not contain any specific parameter.

4. A method according to claim 1, in which said reply further includes a geographical area indication relating to a geographical area applicable to said authorization and/or non-authorization.

5. A method according to claim 4, in which said geographical area indication indicates whether said authorization and/or said non-authorization apply solely for said location structure, or for the entire network.

6. A method according to claim 1, in which said request corresponds to a location updating request, and said reply corresponds to the location updating request being accepted or rejected.

7. A method according to claim 1, comprising steps (3) in which:
on receiving said reply, said mobile terminal determines whether the radio access technology supported by said cell corresponds to a radio access technology that is not authorized, as indicated by said reply; and
if the radio access technology is not authorized, the mobile terminal selects another cell that supports a radio access technology that is authorized.

8. A method according to claim 1, including steps (3) in which:
on receiving said reply, the mobile terminal causes information corresponding to at least one non-authorized radio access technology as indicated by said reply to be stored; and
prior to selecting a cell, the mobile terminal verifies that the radio access technology supported by the cell does not correspond to a radio access technology that is not authorized according to the information as stored in this way.

9. A method according to claim 8, in which:
the mobile terminal causes said storage to be performed in a subscriber identity module associated with said mobile terminal.

10. A method according to claim 8, in which said stored information is deleted in the event of changing PLMN.

11. A method according to claim 7, in which said stored information is deleted in the event of said subscriber identity module being withdrawn, or under the control of the user.

12. A mobile terminal (MT) comprising:
means (10) for transmitting to a network entity (CN) in a given cell, a request to register in a location structure including said cell; and
means (11) for receiving from said network entity (CN), in response to said request, a reply including at least one radio access technology indication relating to at least one radio access technology that is authorized and/or to at least one radio access technology that is not authorized for said mobile terminal, at least in said location structure.

13. A mobile terminal according to claim 12, including:
means (12) for acting on receiving said reply to determine whether the radio access technology supported by said cell corresponds to a radio access technology that is not authorized, as indicated by said reply; and
means (13) for acting if the radio access technology is not authorized to select another cell that supports a radio access technology that is authorized.

14. A mobile terminal according to claim 12, including:
means (14) for acting, on receiving said reply, to cause information corresponding to at least one radio access technology that is not authorized as indicated by said response to be stored; and
means (16) for acting, prior to selecting a cell, to verify that the radio access technology supported by said cell does not correspond to a radio access technology that is not authorized according to the information as stored in this way.

15. A subscriber identity module (SIM/USIM) including:
means (15) for storing information corresponding to at least one radio access technology that is not authorized for a mobile terminal associated with said module, as received from a network entity in response to a registration request sent by said terminal.

16. A mobile communications network entity (CN) including:
means (20) for receiving from a mobile terminal (MT) in a given cell, a request to register in a location structure including said cell; and
means (21) for transmitting a reply to the mobile terminal (MT) in response to said request, the reply including at least one radio access technology indication relating to at least one radio access technology that is authorized and/or to at least one radio access technology that is not authorized for said mobile terminal, at least in said location structure.
